(19) United States
(12) Patent Application Publication
(10) Pub. No.: US 2014/0285420 A1
(43) Pub. Date: Sep. 25, 2014

(54) IMAGING DEVICE, DISPLAYING DEVICE, MOBILE TERMINAL DEVICE, AND CAMERA MODULE

(71) Applicant: FUJITSU LIMITED, Kawasaki-shi (JP)

(72) Inventors: Takuya KAMIMURA, Kobe (JP); Hiroyasu YOSHIKAWA, Kawasaki (JP)

(73) Assignee: FUJITSU LIMITED, Kawasaki-shi (JP)

(21) Appl. No.: 14/098,694

(22) Filed: Dec. 6, 2013

(30) Foreign Application Priority Data
Mar. 22, 2013 (JP) 2013-061100

(51) Int. Cl. G06F 3/01; H04N 5/33

(52) U.S. Cl. CPC G06F 3/013; H04N 5/33
USPC 345/156; 348/164

(57) ABSTRACT

An imaging device includes: a radiation unit configured to radiate light with a peak of a specific wavelength; a light receiver configured to have first sensitivity to a first wavelength longer than the specific wavelength, the first sensitivity being lower than second sensitivity to a second wavelength shorter than the specific wavelength; and a filter configured to block the second wavelength.

### CROSS-REFERENCE TO RELATED APPLICATION

This application is based upon and claims the benefit of priority of the prior Japanese Patent Application No. 2013-061100, filed on Mar. 22, 2013, the entire contents of which are incorporated herein by reference.

### FIELD

The embodiments discussed herein are related to an imaging device, a displaying device, a mobile terminal device and a camera module.

### BACKGROUND

For a man-machine interface of a lower user load, eye gaze detection is used. In the eye gaze detection, using a light source to radiate infrared light and an image sensor, a direction of eye gaze is determined from reflection of the infrared light at corneas and positions of pupils.

Related arts are disclosed in Japanese Laid-open Patent Publication Nos. 2000-28315 and 2009-55107.

### SUMMARY

According to an aspect of the invention, an imaging device includes: a radiation unit configured to radiate light with a peak of a specific wavelength; a light receiver configured to have first sensitivity to a first wavelength longer than the specific wavelength, the first sensitivity being lower than second sensitivity to a second wavelength shorter than the specific wavelength; and a filter configured to block the second wavelength.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of an information processing device;

FIG. 2 illustrates an example of a spectral irradiance distribution;

FIG. 3 illustrates an example of a distribution of relative emission intensity;

FIG. 4 illustrates an example of an internal configuration of a camera module;

FIG. 5 illustrates an example of characteristics of an optical filter; and

FIG. 6 illustrates an example of light sensitivity spectroscopic properties.

### DESCRIPTION OF EMBODIMENTS

In a case of radiating infrared light in eye gaze detection, an image sensor with light sensitivity closer to wavelengths of visible light has higher characteristics, so that it is easier to obtain reflection at corneas by radiating near infrared close to the wavelengths of visible light from a light source.

From the light source, components in a wavelength band around a targeted peak wavelength are also radiated. In addition, in the light source, there may be variation between a target wavelength peak and an actually radiated wavelength peak due to an individual difference thereof.

Therefore, in the case where infrared close to wavelengths of visible light is used for the eye gaze detection, components of illumination radiated from the light source may include wavelengths of visible light. Red flickers may appear to a user.

For example, when peak relative emission intensity of illumination radiated from a light source is 850 nm, the illumination includes components in a wavelength band from approximately 750 nm to approximately 900 nm although having low relative emission intensity compared with the peak. Components in a wavelength from 760 nm to 830 nm, which is considered as an upper bound of visible light, may also be included.

In a case of using infrared light away from the wavelengths of visible light for the eye gaze detection, the light sensitivity of an image sensor becomes lower as going away from the wavelengths of visible light. Therefore, compared with a case of radiating a wavelength close to the wavelengths of visible light, reflection at corneas is not easily obtained.

In a case of observing reflection at corneas, sun light and the like other than the illumination may cause adverse effects as disturbing ambient light. The illuminance of the sun light greatly decays in particular wavelengths. For example, in a region overlapping the wavelengths of infrared light, the illuminance of the sun light greatly decays in wavelengths around 935 nm and the like, compared with other wavelength bands.

In order to reduce influence due to the sun light, a bandpass filter is used to transmit, through an image sensor, only particular wavelengths of incident light that is radiated to an object and the particular wavelengths greatly decays the illuminance of sun light.

For example, in a case of using a bandpass filter, a plurality of filters are used in order not to transmit wavelengths shorter and longer than the wavelengths to be transmitted. A bandpass filter becomes greater in size and also becomes expensive compared with high-pass filters and low-pass filters, which transmit only wavelengths more or less than certain wavelengths.

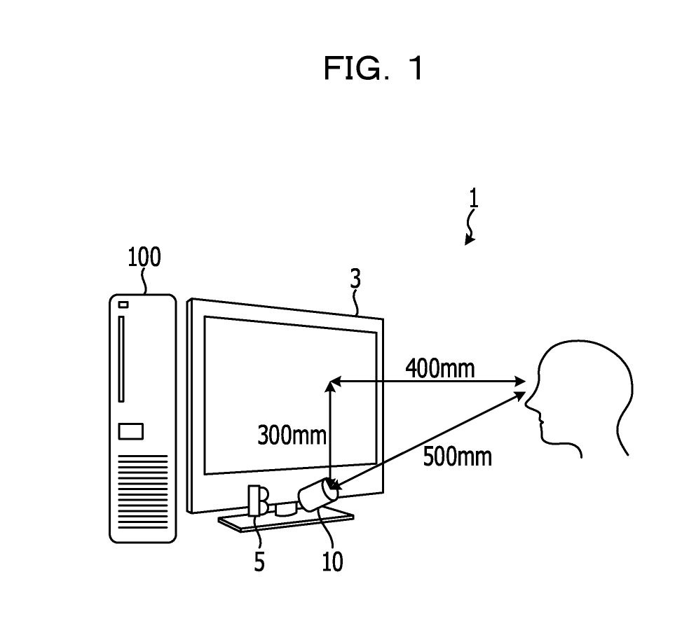

FIG. 1 illustrates an example of an information processing device. In an information processing device 1 illustrated in FIG. 1, an eye gaze detection system is applied as a man-machine interface to reduce a user load. In the information processing device 1, a light emitting diode (LED) 5 and a camera module 10 are provided to a display 3 equipped separately from a main body 100 that provides a function as a computer carrying out information processing.

The LED 5 and the camera module 10 are disposed for eye gaze detection at respective positions where near infrared light radiated by the LED 5 reflects at corneas of a user that browses the display 3 and the cornea reflection is incident on a lens unit 11 of the camera module 10. For example, the LED 5 may be disposed at a position away from the camera module 10 at a certain interval, for example, approximately 5 cm in order not to overlap routes of outgoing light and incident light of the illumination.

The LED 5 may be a light source to radiate near infrared light. For example, the LED 5 radiates near infrared light having an emission intensity peak of a wavelength of approximately 940 nm. The wavelength band including the peak wavelength and the surroundings thereof may overlap a particular wavelength band that causes the illuminance of sun light to greatly decay locally. Although one LED 5 is equipped in FIG. 1, a plurality of LEDs 5 may also be equipped.

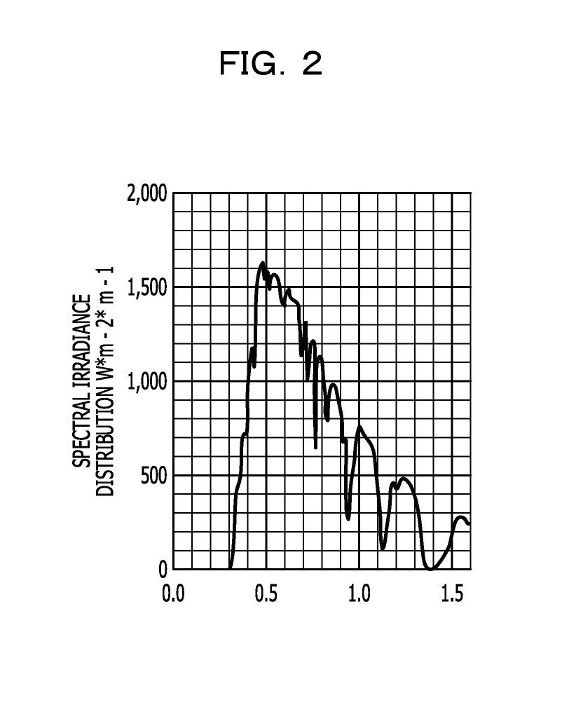

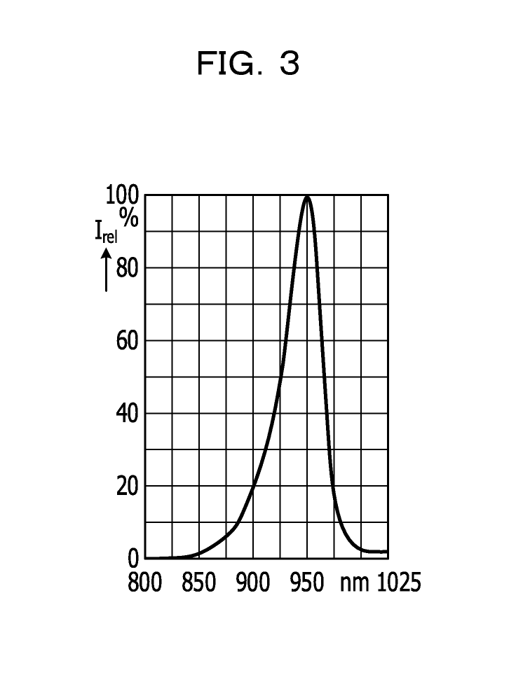

FIG. 2 illustrates an example of a spectral irradiance distribution. FIG. 3 illustrates an example of a distribution of relative emission intensity. A vertical axis illustrated in FIG. 2 indicates the illuminance, and a horizontal axis illustrated in FIG. 2 indicates the wavelength. A vertical axis illustrated in FIG. 3 indicates the relative emission intensity, and a horizontal axis illustrated in FIG. 3 indicates the wavelength. As illustrated in FIG. 2, the sun light has a tendency that the illuminance gradually becomes weaker as the wavelength becomes longer as an overall tendency in the infrared region, and the illuminance is greatly lowered in a wavelength band between 900 nm and 1000 nm. For example, the illuminance of sun light rapidly drops in from the wavelengths shorter than around 935 nm to around 935 nm, and gradually rises from the vicinity beyond around 935 nm compared with the drop from the wavelength shorter than around 935 nm. As illustrated in FIG. 3, the illumination light has an intensity distribution with a peak at the wavelength of 940 nm, and has an intensity distribution with bottom areas, away from the peak, extending in a wavelength band from 850 nm to 1000 nm. For example, the wavelength band between 900 nm and 1000 nm, where the illuminance of sun light greatly decays, may overlap the peak and the bottom areas of the near infrared light to be radiated by the LED 5.

Therefore, among components of the light received by the camera module 10, the intensity of the sun light components to be disturbance in the wavelength band subjected to the detection of cornea reflection is lowered, and thus the intensity of illumination components may be improved relatively.

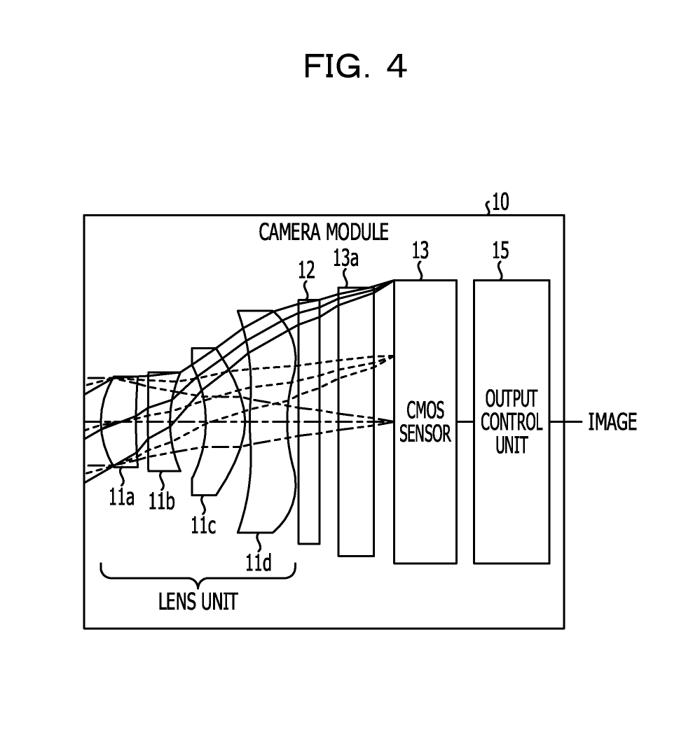

The camera module 10 may be an imaging device to convert light received via the lens unit 11 to an electrical signal. FIG. 4 illustrates an example of an internal configuration of a camera module. As illustrated in FIG. 4, the camera module 10 includes the lens unit 11, a short wavelength cut filter 12, a cover glass 13a, a complementary metal-oxide semiconductor (CMOS) sensor 13, and an output control unit 15.

The lens unit 11 may be a lens group that forms an image of incident light from outside on the CMOS sensor 13. For example, a user may browse the display 3 at a position approximately 400 mm horizontally away from the front of the display 3 and also the camera module 10 may be disposed at a position approximately 300 mm vertically downward away from the front center of the display 3. At this time, a distance from the camera module 10 to the corneas of the user may be approximately 500 mm. In such disposition, so as to allow imaging of the eye area in the face to be a target of eye gaze detection, for example, the cornea reflection and pupils by certain pixels or more, the thicknesses, the number, and the shapes of lenses in the lens unit 11 and the resolution of the CMOS sensor 13 are designed. For example, in FIG. 4, from the incident side in order, a convex lens 11a that narrows the incident light from outside and gathers the incident light on the light receiving surface of the CMOS sensor 13 and lenses 11b through 11d of concave, aspheric, and the like that suppresses distortion in the image plane, so-called, distonation and color blurring may be equipped.

In FIG. 4, the lens unit 11 of the camera module 10 is configured by combining concave, convex, and aspheric lenses using the four lenses of the lenses 11a through 11d. The lens unit 11 does not have to be configured with four lenses. The thicknesses, the number, and the shapes of lenses in the lens unit 11 and the resolution of the CMOS sensor 13 may be modified arbitrarily according to conditions determined by, for example, electronics having the eye gaze detection implemented therein and an environment where the electronics are used.

The short wavelength cut filter 12 may be an optical filter to remove components less than a certain wavelength from components of the light received via the lens unit 11 and also to transmit components in wavelengths more than or equal to the certain wavelength. The short wavelength cut filter 12 may be referred to as a long pass filter.

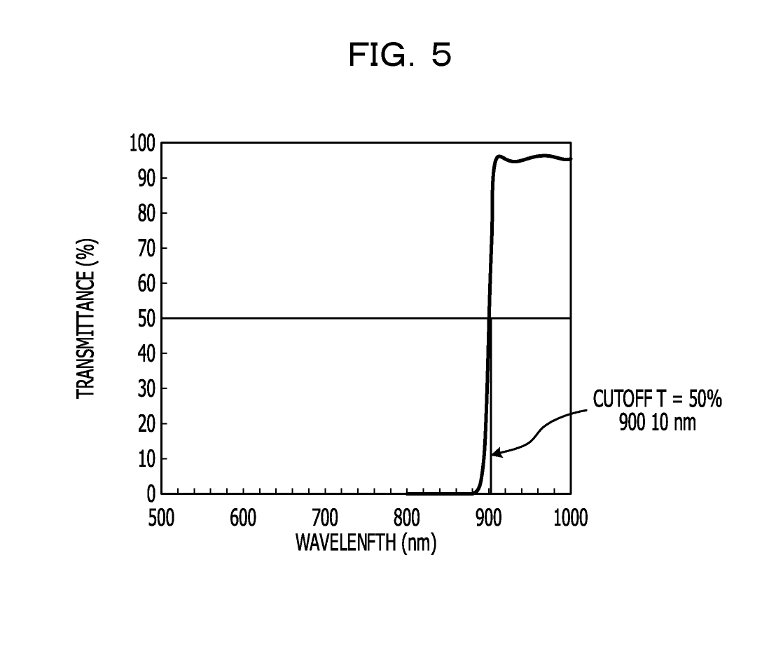

In the short wavelength cut filter 12, so as to block sun light components to be disturbance as much as possible and also to transmit near infrared light components radiated by the LED 5, a cutoff wavelength is set. FIG. 5 illustrates an example of characteristics of an optical filter. A vertical axis in FIG. 5 indicates the transmittance, and a horizontal axis in FIG. 5 indicates the wavelength. As illustrated in FIG. 5, the short wavelength cut filter 12 may have a cutoff wavelength having the transmittance of 50% designed to be 900 nm ±10 nm. The short wavelength cut filter 12 has transmittance dependency to block light of components in wavelengths shorter than 880 nm and also to transmit light of components in wavelengths longer than 930 nm.

Since the short wavelength cut filter 12 is disposed between the lens unit 11 and the light receiving surface of the CMOS sensor 13, disturbance components in wavelengths shorter than the wavelength band of the near infrared light radiated by the LED 5, for example, disturbance components, such as sun light, incandescent light, and krypton lamps, may be blocked. The components of the light to be transmitted through the short wavelength cut filter 12 include components in a wavelength band of the near infrared light radiated by the LED 5, for example, the components in the wavelength band around 940 nm where cornea reflection appears, and also disturbance components such as sun light that terminates local decays at wavelengths beyond 1000 nm.

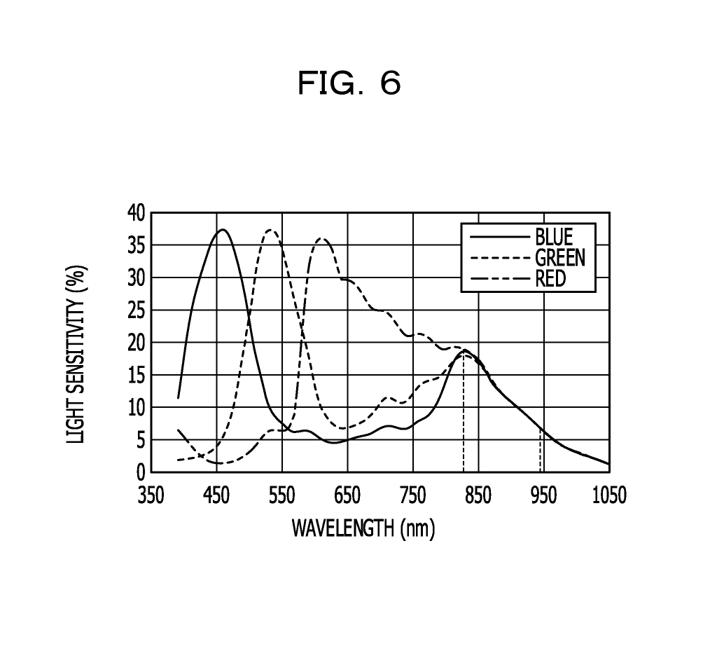

The CMOS sensor 13 may be an imaging device using a complementary metal oxide film semiconductor. For example, the CMOS sensor 13 having the light sensitivity spectroscopic properties illustrated in FIG. 6 is employed.

FIG. 6 illustrates an example of light sensitivity spectroscopic properties. A vertical axis in FIG. 6 indicates the light sensitivity, and a horizontal axis in FIG. 6 indicates the wavelength. A solid line in FIG. 6 indicates the light sensitivity of blue (B) subpixels, a broken line indicates the light sensitivity of red (R) subpixels, and a dash-dotted line indicates the light sensitivity of green (G) subpixels. As illustrated in FIG. 6, while the respective light sensitivities of R, G, and B vary in a wavelength band shorter than a wavelength of approximately 850 nm, the respective light sensitivities do not vary in a wavelength band longer than the wavelength of approximately 850 nm, and the quantum efficiency of photoelectric conversion is lowered gently as the wavelength becomes longer.

In the CMOS sensor 13 having the above light sensitivity spectroscopic properties, while the respective light sensitivities of R, G, and B decline in wavelengths beyond 850 nm and have certain light sensitivities in wavelengths of up to approximately 950 nm, the light sensitivities beyond 1000 nm become roughly zero. Therefore, among the components to be transmitted through the short wavelength cut filter 12, disturbance components, such as sun light, which terminates local decay in wavelengths beyond 1000 nm, may not be easily converted to a signal while components in a wavelength band around 940 nm where cornea reflection appears may be easily converted to a signal.

As just described, among the disturbance components, the components in wavelengths shorter than the wavelength band around 940 nm are blocked by the short wavelength cut filter 12. Since the illuminance of sun light to be a main component of disturbance greatly decays in a wavelength band between 900 nm and 1000 nm among the disturbance components transmitted through the short wavelength cut filter 12, the intensity of the wavelength band around 940 nm radiated by the LED 5 becomes relatively high. Since the light sensitivity of the CMOS sensor 13 is suppressed by the respective color components in the wavelengths beyond 1000 nm where the local decay of sun light terminates among the disturbance components transmitted through the short wavelength cut filter 12, photoelectrical conversion is not easily performed. In order to block the components in the wavelengths shorter than a wavelength band around 940 nm where cornea reflection appears and also in order to reduce the quantum efficiency of photoelectric conversion of long wavelength components, photoelectric conversion is performed by narrowing down to the wavelength band around 940 nm where cornea reflection appears. Therefore, the signal to noise (S/N) ratio may be improved.

The output control unit 15 executes output control of a signal output by the CMOS sensor 13. For example, the output control unit 15 amplifies a signal output by the CMOS sensor 13 or carries out analog to digital (AD) conversion, thereby outputting digital signals of a generated image to a certain output destination. For example, the output destination may be the main body 100 of the information processing device 1. In the main body 100, the center of gravity of cornea reflection and the center of gravity of pupils are detected from an image reflecting user's eyes, and relative displacement of the center of gravity of cornea reflection and the center of gravity of pupils are converted to an eye gaze angle, thereby detecting an eye gaze direction. For example, the eye gaze direction may be used for an operation, such as automatic scroll and zoom of a screen.

The information processing device 1 uses a short wavelength cut filter that blocks components in wavelengths shorter than a wavelength of an emission intensity peak of illumination and an image sensor that reduces light sensitivity of components in wavelengths longer than the peak wavelength, so that the device scale and the costs may be reduced.

For example, seeing from the light sensitivity spectroscopic properties of a CMOS sensor illustrated in FIG. 6, the light sensitivity of components in wavelengths around approximately 850 nm is higher than the light sensitivity of components in wavelengths around approximately 940 nm. For example, illumination having an emission intensity peak in a wavelength of approximately 850 nm from the LED 5 may efficiently photoelectrically convert components in wavelengths where cornea reflection appears. However, the irradiance of sun light does not greatly decay in a wavelength band around approximately 850 nm and the disturbance is also severe. Therefore, even when it is possible to obtain sufficient intensity of a signal by the illumination having an emission intensity peak in a wavelength approximately 850 nm from the LED 5, the disturbance may be severe or the S/N ratio may not become larger. Therefore, an image having a state of cornea reflection imaged well may not be obtained.

For example, in a case of carrying out radiation having an emission intensity peak in a wavelength of approximately 940 nm from the LED 5, the intensity of signal becomes lower than radiation having an emission intensity peak in a wavelength of approximately 850 nm while the irradiance of sun light greatly decays in a wavelength band from approximately 900 nm to approximately 1000 nm as illustrated in FIG. 2. Therefore, the emission intensity in a wavelength band around 940 nm radiated by the LED 5 becomes relatively higher than the intensity of the disturbance components, and thus the S/N ratio may be improved. Therefore, an image having a state of cornea reflection imaged well may be obtained.

Among the disturbance components, components in wavelengths shorter than a wavelength band around 940 nm are blocked by the short wavelength cut filter 12. Among the disturbance components, a long wavelength cut filter is not used for wavelengths beyond 1000 nm where cornea reflection does not appear. For example, utilizing the light sensitivity spectroscopic properties of a CMOS sensor in which the light sensitivity becomes deteriorated in wavelengths beyond 1000 nm, the disadvantage of light sensitivity may be utilized as a long wavelength cut filter, for example, a short pass filter. Therefore, the S/N ratio may be improved without using a bandpass filter in order to reduce disturbance components, and thus the device scale and the costs may be reduced.

The LED 5 and the camera module 10 above may be applied to the information processing device 1 or arbitrary electronics.

For example, the LED 5 and the camera module 10 above may also be applied to a personal computer or a mobile communication device, such as a smartphone, a mobile telephone, and a PHS, and may also be applied to a tablet terminal, such as a PDA not coupled to a mobile communication network. In a case where a main body and a displaying device are configured separately as a desktop personal computer, an image taken by the camera module 10 may be output on a display and the result of detection of eye gaze direction may also be input to the main body by the display.

The short wavelength cut filter 12 may be disposed between the lens unit 11 and the CMOS sensor 13. Coating having substantially similar optical characteristics may also be applied on a protective plate disposed in front of the lens unit 11.

Near infrared light may also be radiated to the LED 5, and other light may also be radiated. For example, the irradiance of sun light even in wavelengths of visible light greatly decays in the vicinity from 758 nm to 760 nm compared with wavelengths adjacent to the vicinity. Therefore, even in a case of observing an image of chlorophyll fluorescence of a plant, the LED 5 and the camera module 10 above may assist. Using a light receiving element having light sensitivity dropped in any wavelengths adjacent to 758 nm through 760 nm with a short wavelength cut filter or a long wavelength cut filter, light in a desired wavelength, for example, light only in a desired wavelength may be obtained without using a bandpass filter.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An imaging device comprising:
a radiation unit configured to radiate light with a peak of a specific wavelength;
a light receiver configured to have first sensitivity to a first wavelength longer than the specific wavelength, the first sensitivity being lower than second sensitivity to a second wavelength shorter than the specific wavelength; and
a filter configured to block the second wavelength.

2. The imaging device according to claim 1, wherein the light receiver is a CMOS sensor.

3. The imaging device according to claim 1, wherein radiation emitted at a wavelength of the light radiated by the radiation unit is reduced compared with adjacent wavelengths from sun light.

4. A displaying device comprising:
an imaging unit including:
a radiation unit configured to radiate light with a peak of a specific wavelength; and
a light receiver configured to have first sensitivity to a first wavelength longer than the specific wavelength, the first sensitivity being lower than second sensitivity to a second wavelength shorter than the specific wavelength and to have a filter to block the second wavelength, and
a detector configured to detect an eye gaze direction using positions of a pupil and cornea reflection obtained from an image taken by the imaging unit.

5. The displaying device according to claim 4, wherein the displaying device is assembled in an information processing device.

6. A mobile terminal device comprising:
an imaging unit including:
a radiation unit configured to radiate light with a peak around a specific wavelength; and
a light receiver configured to have first sensitivity to a first wavelength longer than around the specific wavelength, the first sensitivity being lower than second sensitivity to a second wavelength shorter than the specific wavelength, and
a detector configured to detect an eye gaze direction using positions of a pupil and cornea reflection obtained from an image taken by the imaging unit.

7. A camera module having a short wavelength cut filter that blocks components in wavelengths shorter than a wavelength at an emission intensity peak of illumination, and an image sensor with reduced sensitivity to components in wavelengths longer than the wavelength at the peak of illumination.

8. An imaging device comprising:
a light receiver disposed to receive light with a peak of a specific wavelength from an emitter, the light receiver having first sensitivity to a first wavelength longer than the specific wavelength and second sensitivity to a second wavelength shorter than the specific wavelength, the first sensitivity being lower than second sensitivity; and
a filter disposed between the emitter and the light receiver to block the second wavelength.
